(19) United States
(12) Patent Application Publication
(10) Pub. No.: US 2026/0023464 A1
(43) Pub. Date: Jan. 22, 2026

(54) TECHNIQUES FOR VISUALIZATION AND MODIFICATION OF OBJECTS IN ANIMATIONS

(71) Applicant: NETFLIX, INC., Los Gatos, CA (US)

(72) Inventor: Matthew Karl NOBLE, Falmouth, MA (US)

(21) Appl. No.: 18/773,867

(22) Filed: Jul. 16, 2024

(51) Int. Cl. G06F 3/04842; G06T 13/80

(52) U.S. Cl. CPC G06F 3/04842; G06T 13/80

(57) ABSTRACT

A technique for interacting with objects included in an animation, the technique including deserializing a boundary file that includes serialized boundary data for one or more objects included in the animation to generate structured boundary data for the one or more objects, determining a current cursor position within a current frame of the animation, and determining a selected object within the current frame of the animation based on the current cursor position within the current frame and the structured boundary data.

### BACKGROUND

### Field of the Invention

Embodiments of the present disclosure relate generally to computer science and animation technology and, more specifically, to techniques for visualization and modification of objects in animations.

### Description of the Related Art

Animation is a technique in which a sequence of individual images that include one or more objects are generated and manipulated in a way that causes the one or more objects to appear to move as the sequence of individual images is played back for a viewer. In computer-based animation, an animation can include a sequence of image frames, each frame having one or more layers of visual content. An animation also includes one or more transitions, each of which includes a transition/change of a particular property of a particular layer of visual content across multiple frames of the animation. For example, a first object in an animation can have a first transition that is a transition/change of an opacity property (e.g., from high opacity to low opacity) of the first object across frames 10-17 of the animation. A single object can also have different transitions of the same or different properties through the duration of the animation. The animation can be generated and modified using an animation application that is used to generate one or more objects of the animation and to define transition parameters of one or more transitions within the animation. In particular, an animation application can be used to specify and modify, via transition parameters, one or more transitions associated with various objects of the animation. A finalized animation can then be utilized in any variety of media, such as web pages, user interfaces, video games, visual effects, videos, animated GIFs (Graphic Interchange Format images), and any other media displaying moving images.

One drawback of conventional animation applications is that these applications typically do not provide latency-free and efficient identification and visualization of selected objects within the animation. Initially, a conventional animation application can display a particular frame of an animation that is made up of layered objects and transition parameters associated with those objects. The animation application can also enable a user to select particular objects within the particular frame, e.g., by hovering a cursor over the objects. In addition, the animation application can identify and highlight the selected objects as the user moves the cursor over the different areas within the frame. However, in addition to the boundary data for the objects, the animation source file can contain large amounts of object metadata for each object in each frame of the animation (including the visual content of the object), as well as large amounts of transition metadata for each transition associated with an object of the animation. As a result of the large amounts of object metadata and transition metadata, determining the objects being selected using the animation source file can require significant processing time and resources. As such, conventional animation applications do not provide seamless (lag free) and efficient identification and visualization (e.g., highlighting) of selected objects within an animation frame as the user moves the cursor over different areas in the frame to select and modify various objects.

After selecting a particular object within an animation frame, a user can modify the object, which can include modifying one or more transitions associated with the object by changing one or more transition parameters. However, another drawback of conventional animation applications is that these application typically do not visually indicate (e.g., highlight) the transitions and transition parameters associated with a selected object. Instead, conventional animation applications can display a large number of transitions and transition parameters associated with multiple objects in an animation frame, without visually indicating (e.g., highlighting) which of the displayed transitions and transition parameters are associated with a particular object that a user selects. Thus, with conventional animation applications, the user also cannot easily identify, review, and modify the transitions and transition parameters associated with a selected object in an animation.

As the foregoing illustrates, what is needed in the art are more effective techniques for interacting with visual content when generating animations.

### SUMMARY OF THE EMBODIMENTS

One embodiment of the present disclosure sets forth a computer-implemented method for interacting with objects included in an animation, the method including deserializing a boundary file that includes serialized boundary data for one or more objects included in the animation to generate structured boundary data for the one or more objects, determining a current cursor position within a current frame of the animation, and determining a selected object within the current frame of the animation based on the current cursor position within the current frame and the structured boundary data.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques provide an improved user interface for an animation application that does not require the animation application to access animation source files to identify and visualize selected objects in animations. As such, the improved user interface can provide relatively seamless (lag-free) and efficient identification and visualization of selected objects of an animation. In particular, the animation application uses structured boundary data, rather than an animation source file itself, to determine selected objects and display visual indicators of the selected objects. As a result, the animation application can quickly analyze the structured boundary data to determine and display visualizations of selected objects in a manner that is relatively seamless (lag-free). In addition, the disclosed techniques serialize the structured boundary data and store the serialized boundary data as a boundary file associated with the animation source file, which requires a lower amount of storage resources to store the boundary file and a lower amount of processing time and computational resources to load the boundary file during runtime relative to storing the structured boundary data in the boundary file without serialization. Another technical advantage of the disclosed techniques relative to the prior art is that the disclosed techniques visually indicate/highlight any transitions and transition parameters that are associated with a selected object. Thus, the user can more easily identify and modify the transitions and transition parameters associated with the selected object relative to conventional approaches. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a conceptual illustration of a system configured to implement one or more aspects of the various embodiments;

FIG. 2 illustrates an exemplar graphical user interface generated by the animation application of FIG. 1, according to various embodiments;

FIG. 3 illustrates the graphical user interface of FIG. 2 showing a selection of a first object, according to various embodiments;

FIG. 4 illustrates the graphical user interface of FIG. 2 showing a selection of a second object, according to various embodiments;

FIG. 5 is a flow diagram of method steps for pre-processing an animation source file, according to various embodiments; and

FIG. 6 is a flow diagram of method steps for processing an animation source file and associated boundary file during runtime, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

As discussed above, one drawback of conventional animation applications is that these applications typically do not provide latency-free and efficient identification and visualization of selected objects within the animation due to the implementation of the animation source file. Due to the large amounts of metadata contained in the animation source file, determining the objects being selected using the animation source file can require significant processing time and resources. As such, conventional animation applications do not provide seamless (lag free) and efficient identification and visualization (e.g., highlighting) of selected objects within an animation frame as the user moves the cursor over different areas in the frame to select and modify various objects.

An improved user interface is disclosed for an animation application that provides relatively seamless (lag-free) and efficient identification and visualization of selected objects of an animation. In some embodiments, the animation application is configured to perform pre-processing steps on a received animation source file for a particular animation. The pre-processing steps include extracting structured boundary data for each object of the animation across each frame of the animation from the animation source file, serializing the extracted boundary data, and storing the serialized boundary data as a boundary file associated with the animation source file.

During runtime when a user opens the animation source file via the animation application, the animation application de-serializes the serialized boundary data in the boundary file to generate the structured boundary data for the objects of the animation for each frame of the animation. The animation application then utilizes the structured boundary data to identify selected objects and generate visualizations of the boundaries of the selected objects. In particular, the user interface of the animation application includes an animation panel that displays one or more objects of a current frame of the animation. As the user moves the cursor over various areas of the current frame, the animation application seamlessly and efficiently identifies a selected object corresponding to a current cursor position and current frame of the animation via an analysis of the structured boundary data, and the animation application displays a visual indication of the selected object (such as a boundary box for the selected object).

The disclosed techniques also display a visual indication of any transitions and transition parameters that are associated with the selected object. In some embodiments, the user interface of the animation application also includes a transition panel that displays transitions and transition parameters that are associated with the various objects of the animation. In these embodiments, when a particular object is selected in the animation panel, the user interface visually indicates/highlights any transitions and transition parameters associated with the selected object that are displayed in the transition panel. The user can then easily identify and modify the transitions and transition parameters associated with the selected object to generate a modified object, a modified animation, and a modified animation source file for use in any variety of media, such as web pages, user interfaces, video games, and the like.

### System Overview

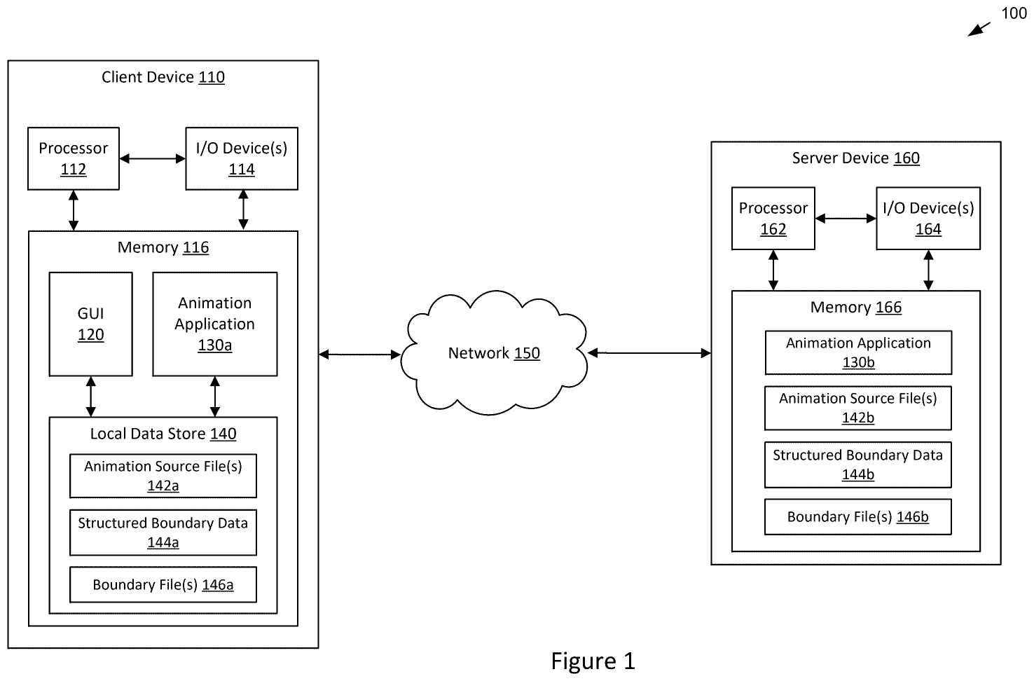

FIG. 1 is a conceptual illustration of a system 100 configured to implement one or more aspects of the various embodiments. As shown, the system 100 includes, without limitation, a client device 110 and a server device 160 in communication over a network 150. The network 150 can be a wide area network (WAN) such as the Internet, a local area network (LAN), or any other suitable network.

The client device 110 includes, without limitation, a processor 112, one or more input/output (I/O) devices 114, and a memory 116. The memory 116 includes, without limitation, a graphical user interface (GUI) 120, an animation application 130a, and a local data store 140. The local data store 140 includes, without limitation, one or more animation source files 142a, structured boundary data 144a, and one or more boundary files 146a. The server device 160 includes, without limitation, a processor 162, one or more I/O devices 164, and a memory 166. The memory 166 includes, without limitation, an animation application 130b, one or more animation source files 142b, structured boundary data 144b, and one or more boundary files 146b.

The client device 110 is configured to execute the animation application 130a residing in the memory 116 on the processor 112 to perform the various embodiments described herein. In other embodiments, the various embodiments described herein can be implemented via cloud-based computing environments whereby any number of components executing the various embodiments can be distributed across multiple geographic locations or implemented in one or more computing devices in any combination. In this regard, the various embodiments described herein can be implemented via the client device 110, the server device 160, or a combination of the client device 110 and the server device 160, as well as zero or more additional computing devices connected via the network 150.

For the sake of clarity, the below sections describe the functionality of the client device 110 for performing the various embodiments via the animation application 130a, the one or more animation source files 142a, the structured boundary data 144a, and the one or more boundary files 146a residing on the client device 110. However, the functionality of the server device 160 for performing the various embodiments described herein can similarly be implemented via the animation application 130b, the one or more animation source files 142b, the structured boundary data 144b, and the one or more boundary files 146b residing on the server device 160. Likewise, the below description of various hardware components of the client device 110 also can apply to the various hardware components of the server device 160.

In various embodiments, the processor 112, 162 receives user input from input devices, such as a keyboard, a mouse, a joystick, a touchpad, or a touchscreen. In operation, the processor 112, 162 is the master processor of the computing device 110 and/or server device 160, controlling and coordinating operations of other system components. For example, the processor can comprise general-purpose processors (such as a central processing unit), special-purpose processors (such as a graphics processing unit), application-specific processors, field-programmable gate arrays, or other programmable logic device, discrete gate or transistor logic, discrete hardware components, or any combination of different processing units. In some embodiments, the processor is a programmable processor that executes program instructions to manipulate input data. In some embodiments, the processor can include any number of processing cores, memories, and other modules for facilitating program execution. In particular, the processor 112, 162 may issue commands that control the operation of a graphics processing unit (GPU) that incorporates circuitry optimized for graphics and video processing, including, for example, video output circuitry. The GPU may deliver pixels to a display device that may be any conventional cathode ray tube, liquid crystal display, light-emitting diode display, or the like.

The input/output (I/O) devices 114, 164 include devices configured to receive user input, including, for example, a keyboard, a mouse, trackball, and so forth. The I/O devices also include devices configured to provide output, including, for example, a display device, a speaker, and so forth. For example, an input device can enable a user to control a cursor displayed on an output device for selecting various elements in the GUI 120 displayed on the output device. Additionally or alternatively, the I/O devices may further include devices configured to both receive and provide input and output, respectively, including, for example, a touchscreen, a universal serial bus (USB) port, and so forth.

Each of the memories 116, 166 includes a memory module, or collection of memory modules. In some embodiments, the memory can include a variety of computer-readable media selected for their size, relative performance, or other capabilities: volatile and/or non-volatile media, removable and/or non-removable media, etc. The memory can include cache, random access memory (RAM), storage, etc. The memory can include one or more discrete memory modules, such as dynamic RAM (DRAM) dual inline memory modules (DIMMs). Of course, various memory chips, bandwidths, and form factors may alternately be selected. The memory stores content, such as software applications and data, for use by the processor 112, 162. In some embodiments, a storage (not shown) supplements or replaces the memory. The storage can include any number and type of external memories that are accessible to the processor 112, 162. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in each of the memories 116, 166 generally stores one or more application programs including the animation application 130, and data (e.g., the one or more source files 142, the structured boundary data 144, and the one or more boundary files 146 stored in the local data store 140) for processing by the processor 112, 162. In various embodiments, the memory can include non-volatile memory, such as optical drives, magnetic drives, flash drives, or other storage. In some embodiments, separate data stores, such as one or more external data stores connected via the network 150 (“cloud storage”) can supplement the memory. In various embodiments, the animation application 130 within the memory 116, 166 can be executed by the processor 112, 162 to implement the overall functionality of the client device 110 and/or server device 160 to coordinate the operation of the system 100 as a whole.

An animation application 130a and 130b (referred to herein collectively as animation applications 130 and individually as a client application 130) resides in each of the memories 116, 166 and executes on the processor 112, 162 of the client device 110 and the server device 160, respectively. The animation application 130a generates and displays the GUI 120 and interacts with a user via the GUI 120. The GUI 120 can be any type of user interface that allows users to interact with one or more software applications via any number and/or types of GUI elements. The animation application 130a can be configured to display, generate, and/or modify animations via the GUI 120. In some embodiments, the animation application 130a receives an animation source file 142a that includes source code for an animation, whereby the animation can be fully rendered and displayed by executing the source code. The animation source file 142a can be in different types of formats, such as GIF, MPEG, SVG, JSON, or other types of formats.

In general, an animation includes a sequence/series of image frames, each frame including one or more objects (layers) of digital visual content. An animation can also be referred to as a video. An object can include an image, text, another video, or any other type of digital visual content. An object can also be referred to as a layer. A frame can include a plurality of layered objects, each object being assigned to a different layer (from layers 1-X), such as from a top layer closest to a user/viewer (such as layer 1) to a bottom layer farthest from the user/viewer (such as layer X). In some instances, a frame can typically include 12 or more layered objects. An animation also includes one or more transitions associated with the one or more objects, each transition being associated with a particular object. In particular, each transition includes a transition/change of a particular property of a particular object across multiple frames of the animation. For example, a first object can have an associated first transition that includes a transition/change of an opacity property (e.g., from high opacity to low opacity) of the first object across frames 10-17 of the animation. A single object can have different transitions of the same or different properties through different frame ranges of the animation. Each transition of an object is specified via transition parameters that define and specify the transition.

As such, the animation source file 142 includes a large amount of animation metadata that includes object metadata that describes and specifies each object through each frame of the animation, as well as transition metadata that specifies transition parameters that describe transitions of objects across multiple frames of the animation. In particular, the animation source file 142 can include, for each object and for each frame of the animation, object metadata that describes and specifies a unique object/layer identifier (ID) for the object/layer (which also specifies the assigned layer), the visual content of the object, and boundary data. The animation source file 142 can also include, for each object of the animation, transition metadata that specifies zero or more transitions associated with the object via a set of transition parameters for each transition.

Thus, the animation metadata of the animation source file 142 includes a significantly large amount of data, which is typically stored in conventional data structures that requires a significant amount of storage space as well as a significant amount of processing time and resources to load and analyze the animation metadata. Conventional animation applications typically implement the large amounts of animation metadata in the animation source file 142 to determine and visualize boundaries of the objects as the user moves the cursor over the various objects within the frame. Thus, determining boundaries of the individual objects using the animation metadata of the animation source file 142 requires significant processing time and resources, and thus does not allow for seamless (lag-free) or efficient determination and visualization of the boundaries of the user-selected objects within the frame.

In some embodiments, the animation application 130 performs a set of pre-processing steps (prior to runtime) for a received animation source file 142, including extracting structured boundary data for one or more objects of each frame of the animation from the animation metadata of the animation source file 142 to generate structured boundary data 144. The set of pre-processing steps also includes serializing the structured boundary data 144 to generate serialized boundary data, and then storing the serialized boundary data as a boundary file 146. The boundary file 146 is then stored and associated with the original animation source file 142 for later use during runtime when the animation source file 142 is opened by the user.

The structured boundary data 144 is extracted from the animation metadata of the animation source file 142 and includes boundary data for each object across each frame of the animation. In some embodiments, only the boundary data is extracted from the animation source file 142 and the remaining animation metadata is not extracted to generate the structured boundary data 144. The extracted boundary data can retain some or all of the data structure of the animation metadata. An example of coding that specifies a portion of the structured boundary data 144 relating to a first object/layer is shown below as Coding Example 1 (which includes a first object data structure generated for the first object/layer):

Coding Example 1.

// Frames for a single layer
const frames = [
{ x: 1, y: 2, width: 100, height: 200 },
{ x: 1, y: 2, width: 100, height: 200 },
{ x: 1, y: 2, width: 100, height: 200 },
{ x: 5, y: 6, width: 500, height: 600 },
null,
null,
null,
];

The boundary data for a particular object specifies a boundary of the object within a particular frame. In some embodiments, the boundary data for a particular object defines and specifies a boundary box that overlaps the boundary of the object and encloses the object. The boundary data for a particular object for a particular frame can include 4 values: x, y, width, and height. The x and y values can specify the upper-left corner of the boundary box that encloses the object, the width value can specify the width of the boundary box, and the height value can specify the height of the boundary box. In some embodiments, the values are in pixel units, whereby the upper-left corner of the display screen has the pixel values of x=0 and y=0 (i.e., coordinates 0, 0). In other embodiments, the values for the boundary data are in other units and another type of coordinate system is used for the boundary data.

In the above Coding Example 1, the animation includes a total of 7 frames and the first object data structure generated for the first object/layer (Object1/Layer1) includes boundary data for the first object/layer for each of the 7 frames of the animation. In some embodiments, each frame of the animation corresponds to a single line of code in the first object data structure, which allows for rapid and efficient analysis and searching the first object data structure. As shown in Coding Example 1, in each of frames 1-3, the boundary box of the first object is located at x, y coordinates (1, 2), has a width of 100, and has a height of 200. In frame 4, the boundary box of the first object is located at x, y coordinates (5, 6), has a width of 500, and has a height of 600. Thus, in frame 4, the first object has moved location and has expanded in size, possibly from a scaling operation. In each of frames 5-7, there is no boundary box for the first object (null), indicating that the first object has been removed from frames 5-7 (does not appear in frames 5-7). Each of the other objects in the animation will likewise have a corresponding object data structure that stores boundary data across each of the 7 frames in the animation. Thus, the overall structured boundary data 144 will include boundary data for each object in the animation across each of the 7 frames in the animation.

The animation application 130 can extract the structured boundary data 144 from the animation source file 142 using various techniques. In some embodiments, the animation application 130 can implement an extensible application programming interface (API) to query the animation source file 142 for the structured boundary data 144. In some embodiments, the animation application 130 can search for and extract the boundary data included in the animation source file 142 using a top layer to bottom layer approach, which is how the animation metadata in the animation source file 142 is typically organized. In these embodiments, the animation application 130 first locates the boundary data for a first object/layer included in the animation source file 142, extracts the boundary data for the first object/layer for each frame of the animation, and then stores the extracted boundary data in a first object data structure that is associated with the object/layer identifier (such as Object1/Layer1) of the first object/layer. The animation application 130 then locates the boundary data for a second object/first layer included in the animation source file 142, extracts boundary data for the second object/layer for each frame of the animation, and then stores the extracted boundary data in a second object data structure that is associated with the object/layer identifier (such as object2/layer2) of the second object/layer. The animation application 130 continues in this manner until all boundary data for all objects across all frames of the animation are extracted and stored to a plurality of object data structures that are associated with the corresponding objects, the plurality of object data structures comprising the structured boundary data 144. In other embodiments, the animation application 130 can extract the structured boundary data 144 from the animation source file 142 using other techniques. As described below, the structured boundary data 144 is used later during runtime to identify and visualize boundaries for selected objects in the animation.

The pre-processing steps also include serializing the structured boundary data 144, and storing the serialized boundary data as a boundary file 146 that is associated with the original animation source file 142. In this regard, for each object data structure comprising boundary data for a particular object/layer across each frame of the animation, the animation application 130 serializes the object data structure to generate object serialized data that also specifies the boundary data for a particular object/layer across each frame of the animation. An example of code specifying object serialized data for a first object/layer that corresponds to the first object data structure for the first object/layer of Coding Example 1, is shown below as Coding Example 2:

Coding Example 2.

// Serialized output
‘1 2 100 200 r2 5 6 500 600 e3’

In some embodiments, the serialized boundary data is also generated by the animation application 130 using a predetermined format and predetermined token identifiers. In these embodiments, a subset of boundary data included in the serialized boundary data adheres to a predetermined format. The subset of boundary data includes a sequence/grouping of four numerical values that adheres to the predetermined format. The sequence/grouping of four numerical values can specify, in order, the x coordinate value, the y coordinate value, the width value, and the height value of the object in a particular frame. The serialized boundary data is also generated by the animation application 130 using predetermined token identifiers (shorthand or abbreviated notations) that significantly reduces the amount of coding and storage required for the resulting boundary file 146. The predetermined token identifiers can include a first token identifier that indicates a particular subset of boundary data for a particular frame is repeated (i.e., the same) for one or more other frames. In some embodiments, the first token identifier includes a single character (such as “r” for repeat) followed by a value X, which indicates that a subset of boundary data for a previous frame is repeated (i.e., the same) for the next X number of frames. The predetermined token identifiers can also include a second token identifier that indicates that an object does not appear in one or more particular frames. In some embodiments, the second token identifier includes a single character (such as “e” for empty/null) followed by a value Y, which indicates that the object does not appear in the next Y number of frames.

Thus, in Coding Example 2, the first subset of boundary data “1 2 100 200” includes a grouping of four numerical values in the predetermined format that specifies boundary data for frame 1. In particular, the subset of boundary data specifies that for frame 1, the boundary box of the first object is located at x, y coordinates (1, 2), has a width of 100, and has a height of 200. In Coding Example 2, the token identifier “r2” indicates that the subset of boundary data “1 2 100 200” for frame 1 is repeated for the next 2 frames (i.e., frames 2-3). In Coding Example 2, the second subset of boundary data “5 6 500 600” includes a grouping of four numerical values in the predetermined format that specifies boundary data for frame 4. In particular, the subset of boundary data specifies that for frame 4, the boundary box of the first object is located at x, y coordinates (5, 6), has a width of 500, and has a height of 600. In Coding Example 2, the token identifier “e3” indicates that the first object does not appear in the next 3 frames (i.e., frames 5-7). Thus, Coding Example 2 includes a serialized and more compact version of Coding Example 1. As such, Coding Example 2 specifies the same boundary data for the first object/layer across each frame of the animation as Coding Example 1.

The animation application 130 can serialize the structured boundary data 144 using various techniques. In some embodiments, the animation application 130 can first locate and serialize a first object data structure having boundary data for a first object/layer included in the structured boundary data 144 to generate first object serialized data, which is then associated with the object/layer identifier (such as Object1/Layer1) for the first object/layer. The animation application 130 can then locate and serialize a second object data structure having boundary data for a second object/layer included in the structured boundary data 144 to generate second object serialized data, which is associated with the object/layer identifier (such as object2/layer2) for the second object/layer. The animation application 130 continues in this manner until all boundary data for all objects for all frames in the structured boundary data 144 are serialized and stored as a plurality of object serialized data that are associated with the corresponding objects, the plurality of object serialized data being stored to a boundary file 146. The boundary file 146 is then associated (e.g., via metadata or linked) with the original animation source file 142. In other embodiments, the animation application 130 can serialize the structured boundary data 144 using other techniques. As described below, the boundary file 146 is later deserialized to generate/recreate the initial structured boundary data 144 during runtime.

In general, the structured boundary data 144 that includes non-serialized boundary data having an explicit structure, such as arrays, lists, data fields, and the like. For example, the structured boundary data 144 can include a deserialized object, a JavaScript object, and the like. In general, serialized boundary data includes a string/series of values and characters with minimal or no structure. For example, the serialized boundary data can include a single stream of data. The serialized boundary data has less structure than the structured boundary data 144, and thus advantageously has less overhead. Thus, the resulting boundary file 146 storing serialized boundary data requires lower amounts of storage space and processing time and resources to load at runtime than if the boundary file 146 stores structured boundary data 144.

The pre-processing stage of the received animation source file 142 ends after the boundary file 146 is stored and associated with the received animation source file 142. A runtime phase is initiated, for example, when the user later opens the animation source file 142 for an animation via the animation application 130. During runtime, the animation application 130 generates and displays a GUI 120 comprising an animation panel, a transition panel, and a timeline panel. The animation application 130 can render and display the animation in the animation panel based on the animation metadata in the animation source file 142. The transition panel displays transition parameters for one or more transitions associated with one or more objects of the animation based on the transition metadata in the animation source file 142. The timeline panel displays one or more timelines associated with one or more objects of the animation based on the transition metadata in the animation source file 142.

As the animation application 130 generates and displays the animation in the animation panel, the transition parameters in the transition panel, and the timelines in the timeline panel, the animation application 130 can also concurrently/simultaneously locate, load, and deserialize the boundary file 146 associated with the animation source file 142. In particular, the animation application 130 deserializes the serialized boundary data in the boundary file 146 to generate the initial structured boundary data 144 for all objects across all frames of the animation. For example, the animation application 130 can deserialize the first object serialized data for the first object/layer shown in Coding Example 2 to generate the first object data structure for the first object/layer shown in Coding Example 1. The animation application 130 can do so based on the predetermined format for the subsets of boundary data and the predetermined token identifiers.

The animation application then utilizes the recreated structured boundary data 144 to generate visualizations of the boundaries of objects. The user can interact with the animation displayed in the animation panel, for example, to playback the entire animation, or freeze on a current frame of interest to interact with objects in the current frame. In particular, the user can move the cursor over the various objects in the current frame to select objects to review and/or modify transition parameters associated with the selected objects. As the user moves the cursor over various areas of the current frame of the animation, the animation application 130 determines a selected object corresponding to a current cursor position and current frame of the animation via the recreated structured boundary data 144, and displays a visualization of the boundaries of the selected object (such as boundary indicators).

Because the structured boundary data 144 only includes the boundary data extracted from the animation source file 142 (and not the other types of animation metadata), analyzing and searching the structured boundary data 144 for boundaries of selected objects is significantly more rapid and efficient than using the entire animation source file 142 as in prior approaches, and thus can provide seamless (lag-free) and efficient identification and visualization of selected objects of an animation. Advantageously, having the boundary data in a structured form (rather than serialized form) also improves the speed and efficiency of the analysis and searching of the structured boundary data 144 for selected objects. For example, in some embodiments, the structure of the boundary data is such that within the object data structure for a particular object, each frame of the animation corresponds to a single line of code in the object data structure, as shown in Coding Example 1 above. As such, the animation application 130 can quickly and efficiently locate a specific line of code of the structured boundary data 144 that corresponds to a current frame of the animation for each object.

For example, based on user inputs, the animation panel displays current frame A in the animation and the cursor is moved to a current position x1, y1 within frame A. In response, the animation application 130 searches the structured boundary data 144 for any object having a boundary box that includes/encloses the current cursor position x1, y1 in the current frame A. An object having such a “matching” boundary box is identified as a selected object. If more than one object has a boundary box that includes/encloses the current cursor position in the current frame A, the object at the layer closest to the viewer is identified as the selected object (i.e., the object having the lower layer number is identified as the selected object).

In some embodiments, the animation application 130 searches the structured boundary data 144 using a top layer (layer 1) to bottom layer approach to ensure the object at the layer closest to the viewer is identified as the selected object. In these embodiments, the animation application 130 first locates and analyzes the first object data structure for the first object/layer (Object1/Layer1) from the structured boundary data 144 to locate the boundary data corresponding to current frame A and determine if the boundary box for the first object/layer encloses the current cursor position within current frame A. If so, the first object/layer is identified as the selected object and the animation application 130 displays a visualization of the boundary box of the first object/layer in current frame A displayed in the animation panel to indicate that the first object/layer is a selected object. For example, the animation application 130 can display boundary indicators that partially or fully enclose the first object/layer in current frame A to indicate that the first object/layer is currently selected.

However, if the first object/layer is not identified as the selected object, the animation application 130 locates and analyzes the second object data structure for the second object/layer (object2/layer2) from the structured boundary data 144 to locate the boundary data corresponding to current frame A and determine if the boundary box for the second object/layer encloses the current cursor position within current frame A. If so, the second object/layer is identified as the selected object and the animation application 130 displays a visualization of the boundary box of the second object/layer in current frame A displayed in the animation panel to indicate that the second object/layer is a selected object. The animation application 130 continues with the searching and analysis of the structured boundary data 144 in a similar manner to the next object/layer until either a selected object is identified or no object is identified as the selected object.

When an object is identified and visually highlighted/indicated as a selected object in the animation panel, the animation application 130 also visually highlights/indicates one or more transitions (and the corresponding transition parameters) associated with the selected object in the transition panel and/or one or more timelines associated with the selected object in the timeline panel. For example, if the first object/layer (Object1/Layer1) is the selected object, then the animation application 130 visually highlights/indicates the boundary box of the first object/layer in the animation panel, visually highlights/indicates one or more transitions (and the corresponding transition parameters) associated with the first object/layer object in the transition panel, and visually highlights/indicates one or more timelines associated with the first object/layer in the timeline panel.

Thus, in the transition panel, the user can easily identify any transitions associated with the selected object and modify the transitions if desired via the corresponding transition parameters. Modifying the transition parameters associated with an object generates a modified object, which in turn generates a modified animation which can be stored as a modified animation source file 142. The modified animation source file 142 can then be used, for example, as an animation in a webpage, user interface, video game, and any other type of media.

### Animation Application User Interface

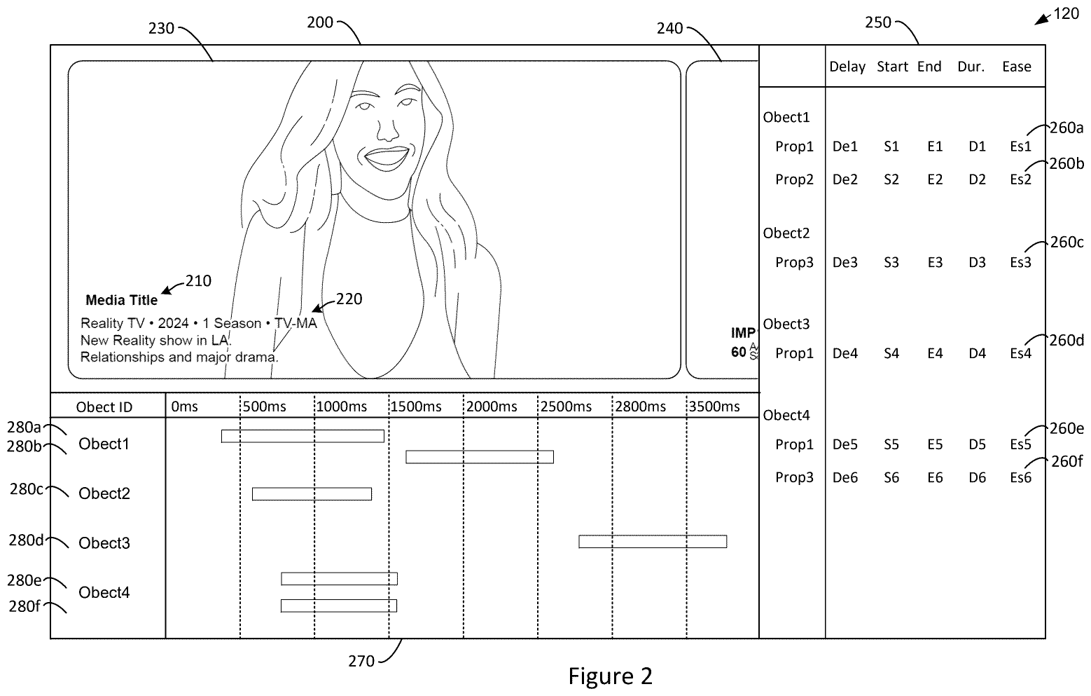

FIG. 2 illustrates an exemplar GUI 120 presented by the animation application 130 of FIG. 1, according to various embodiments. The animation application 130 generates and displays the GUI 120, which includes an animation panel 200, a transition panel 250, and a timeline panel 270. At this runtime stage, the animation application 130 has already pre-processed an animation source file 142 to generate a boundary file 146 comprising serialized boundary data for the animation source file 142. The animation application 130 has also already opened the animation source file 142, rendered and displayed an animation in the animation panel 200 based on the animation metadata in the animation source file 142, generated and displayed any transitions associated with objects of the animation in the transition panel 250 based on the transition metadata in the animation source file 142, and generated and displayed any timelines associated with objects of the animation in the timeline panel 270 based on the transition metadata in the animation source file 142. The animation application 130 has further already deserialized the serialized boundary data in the boundary file 146 to generate structured boundary data 144 associated with the animation.

The animation panel 200 can display a playback of an entire animation from beginning to end, or display specific frames of the animation. The user can control playback of the animation, forward/rewind to specific frames of the animation, and/or pause (freeze) playback at a specific frame of the animation via GUI control buttons (not shown) or predetermined hotkeys. As shown, the user has paused playback at a current frame of the animation, for example, to review and/or modify one or more objects of the current frame. The current frame includes a first object (Object1) 210, a second object (object2) 220, a third object (object3) 230, and a fourth object (object4) 240. Note that the first object (Object1) 210 and the second object (object2) 220 are each layered on top of the third object (object3) 230.

The transition panel 250 can display one or more transitions 260 (such as 260a, 260b, 260c, etc.) associated with objects of the current frame. Each transition 260 includes a change of a particular property of a particular object across multiple frames. Properties of objects that can be transitioned include opacity, x position (for horizontal movement), y position (for vertical movement), width and/or height (for size change), color, and the like. In other embodiments, the properties of an object that can be transitioned include other types of properties. A single object can have one or more associated transitions 260 of the same or different properties. Each transition 260 is defined and specified by a set of transition parameters, such as delay, start, end, duration, easement, or any combination thereof. The delay parameter can specify the time delay before starting the transition relative to the beginning of the animation. The start parameter can specify the start time of the transition relative to the beginning of the animation. The end parameter can specify the end time of the transition relative to the beginning of the animation. The duration parameter can specify the time duration of the transition. The easement parameter can specify an easing curve (motion curve) used to perform the transition. In other embodiments, the set of transition parameters include other types of transition parameters.

As shown in the transition panel 250, the first object (Object1) has two associated transitions, including a first transition 260a and a second transition 260b. The first transition 260a includes a change of a first property (Prop1) that is defined by a first set of transition parameters (De1, S1, Ed1, D1, and Es1). The second transition 260b includes a change of a second property (Prop2) that is defined by a second set of transition parameters (De2, S2, Ed2, D2, and Es2). The second object (Object2) has an associated third transition 260c including a change of a third property (Prop3) that is defined by a third set of transition parameters (De3, S3, Ed3, D3, and Es3). The third object (Object3) has an associated fourth transition 260d comprising a change of the first property (Prop1) that is defined by a fourth set of transition parameters (De4, S4, Ed4, D4, and Es4). The fourth object (Object4) has two associated transitions, including a fifth transition 260e and a sixth transition 260f. The fifth transition 260e includes a change of the first property (Prop1) that is defined by a fifth set of transition parameters (De5, S5, Ed5, D5, and Es5). The sixth transition 260e includes a change of the third property (Prop3) that is defined by a sixth set of transition parameters (De6, S6, Ed6, D6, and Es6).

The timeline panel 270 can display one or more timelines 280 (such as 280a, 280b, 280c, etc.) associated with objects of the current frame. Each timeline 280 associated with an object illustrates a timeline for a particular transition 260 associated with the object. The timelines 280 span the entirety of the animation from beginning to end, and can be divided/sectioned into predetermined time periods (such as 500 ms). Each timeline 280 for a transition includes a visual indicator (such as a rectangle box) that graphically represents the transition. The visual indicator can visually illustrate, for example, a delay between the beginning of the animation and the beginning of the transition, when the transition begins and ends within the animation, and the duration of the transition.

As shown in the timeline panel 270, the first object (Object1) has two associated timelines, including a first timeline 280a corresponding to the first transition 260a, and a second timeline 280b corresponding to the second transition 260b. The second object (Object2) has an associated third timeline 280c corresponding to the third transition 260c. The third object (Object3) has an associated fourth timeline 280d corresponding to the fourth transition 260d. The fourth object (Object4) has two associated timelines, including a fifth timeline 280e corresponding to the fifth transition 260e, and a sixth timeline 280f corresponding to the sixth transition 260f.

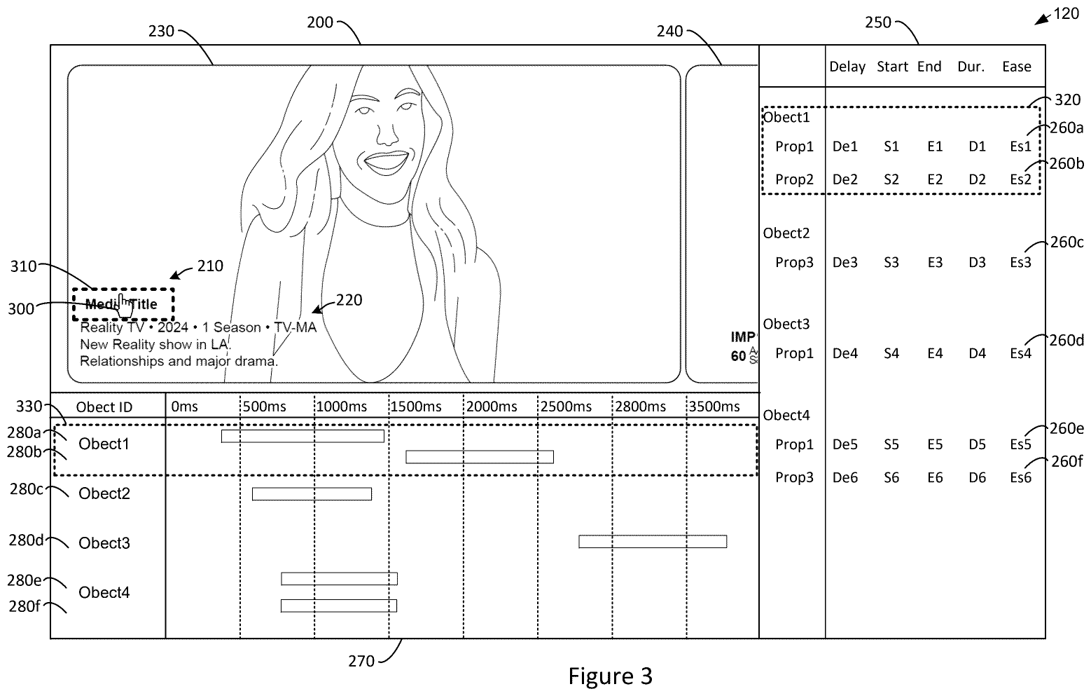

FIG. 3 illustrates the exemplar GUI 120 of FIG. 2 showing a selection of a first object, according to various embodiments. As shown, the user has moved a cursor 300 to a current position that is over the first object (Object1) 210 within the current frame of the animation. The animation application 130 then determines that the first object (Object1) 210 is a currently selected object via analysis of the structured boundary data 144 associated with the animation based on the current cursor position and the current frame. In particular, the animation application 130 determines from the structured boundary data 144 that a boundary box for the first object (Object1) 210 for the current frame encloses the current cursor position.

In response to the determination that the first object (Object1) 210 is a currently selected object, the first object (Object1) 210 is visually indicated/highlighted in the animation panel in some manner by the animation application 130. In some embodiments, the animation application 130 does so by displaying at least a portion of a first boundary box 310 that encloses the first object (Object1) 210, the position and dimensions of the first boundary box 310 being determined based on the boundary data for the first object (Object1) 210 for the current frame in the structured boundary data 144. In these embodiments, the visual indication of the first boundary box 310 can have various forms. For example, the entire boundary of the first boundary box 310 can be visually indicated in the animation panel 200. As another example, only a predetermined portion of the boundary of the first boundary box 310 can be visually indicated, such as only the four corners of the boundary of the first boundary box 310 can be visually indicated in the animation panel 200. In other embodiments, the first object (Object1) 210 is visually indicated/highlighted in the animation panel 200 by decreasing (dimming) the brightness of all objects in the current frame other than the first object (Object1) 210 so that the brightness of the first object (Object1) 210 is significantly higher than all other objects in the current frame. In other embodiments, the first object (Object1) 210 is visually indicated/highlighted in the animation panel 200 by increasing the brightness of the first object (Object1) 210 relative to all other objects in the current frame. In further embodiments, the first object (Object1) 210 is visually indicated/highlighted in the animation panel 200 in a different manner.

In further response to the determination that the first object (Object1) 210 is the currently selected object, the animation application 130 also visually indicates/highlights any transitions 260 (including the transition parameters) associated with the first object (Object1) 210 in the transition panel 250, such as the first transition 260a and the second transition 260b. In some embodiments, the animation application 130 does so by displaying at least a portion of a transition highlight box 320 that encloses the first transition 260a and the second transition 260b associated with the first object (Object1) 210 in the transition panel 250. In other embodiments, the brightness of all transitions 260 other than the first transition 260a and the second transition 260b is decreased (dimmed) so that the brightness of the first transition 260a and the second transition 260b is significantly higher than all other transitions 260 in the transition panel 250. In other embodiments, the brightness of the first transition 260a and the second transition 260b is increased relative to all other transitions 260 in the transition panel 250. In other embodiments, only the first transition 260a and the second transition 260b are displayed in the transition panel 250 and all other transitions 260 are removed from and no longer displayed in the transition panel 250. In further embodiments, the first transition 260a and the second transition 260b are visually indicated/highlighted in the transition panel 250 in a different manner. As such, the user can easily identify the transitions 260 associated with the first object (Object1) 210 in the transition panel 250, and then modify any of the corresponding transition parameters associated with the first object (Object1) 210, for example, by directly modifying one or more values of the corresponding transition parameters displayed within the transition panel 250.

In further response to the determination that the first object (Object1) 210 is the currently selected object, the animation application 130 also visually indicates/highlights any timelines 280 associated with the first object (Object1) 210 in the timeline panel 270, such as the first timeline 280a and the second timeline 280b. In some embodiments, the animation application 130 does so by displaying at least a portion of a timeline highlight box 330 that encloses the first timeline 280a and the second timeline 280b associated with the first object (Object1) 210 in the timeline panel 270. In other embodiments, the brightness of all timelines 280 other than the first timeline 280a and the second timeline 280b is decreased (dimmed) so that the brightness of the first timeline 280a and the second timeline 280b is significantly higher than all other timelines 280 in the timeline panel 270. In other embodiments, the brightness of the first timeline 280a and the second timeline 280b is increased relative to all other timelines 280 in the timeline panel 270. In other embodiments, only the first timeline 280a and the second timeline 280b are displayed in the timeline panel 270 and all other timelines 280 are removed from and no longer displayed in the timeline panel 270. In further embodiments, the first timeline 280a and the second timeline 280b are visually indicated/highlighted in the timeline panel 270 in a different manner.

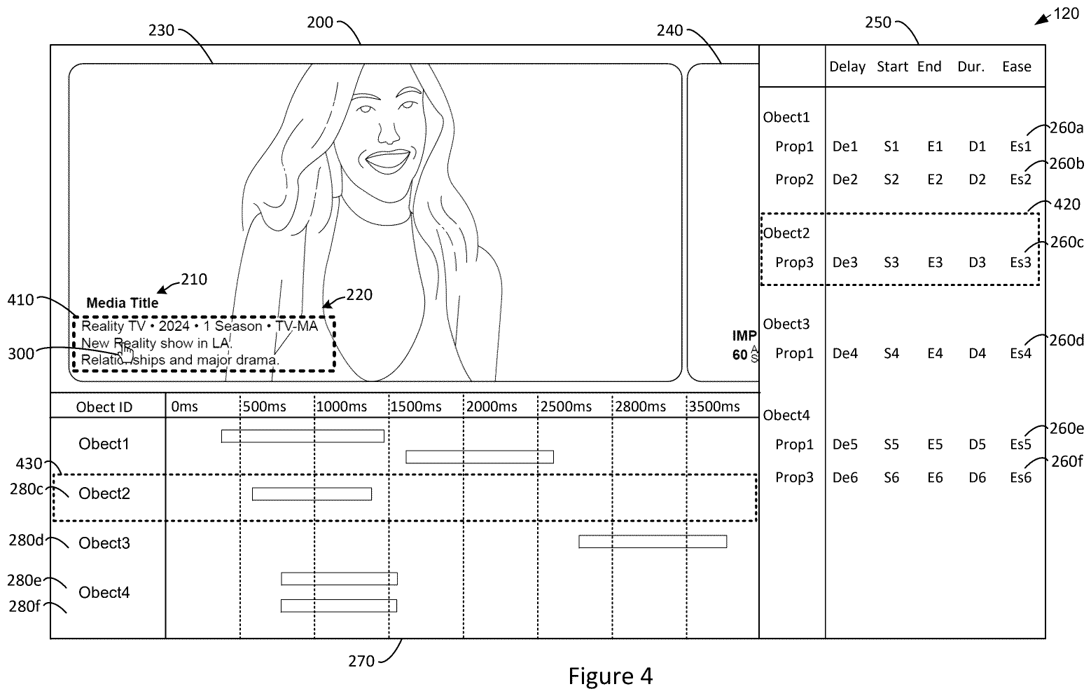

FIG. 4 illustrates the exemplar GUI 120 of FIG. 2 showing a selection of a second object, according to various embodiments. As shown, the user has now moved the cursor 300 to another current position that is over the second object (Object2) 220 within the current frame of the animation. The animation application 130 then determines that the second object (Object2) 220 is the currently selected object via analysis of the structured boundary data 144 associated with the animation based on the current cursor position and the current frame. In particular, the animation application 130 determines from the structured boundary data 144 that a boundary box for the second object (Object2) 220 for the current frame encloses the current cursor position.

In response to the determination that the second object (Object2) 220 is a currently selected object, the second object (Object2) 220 is visually indicated/highlighted in the animation panel in some manner by the animation application 130. In some embodiments, the animation application 130 does so by displaying at least a portion of a second boundary box 410 that encloses the second object (Object2) 220, the position and dimensions of the second boundary box 410 being determined based on the boundary data for the second object (Object2) 220 for the current frame in the structured boundary data 144. In other embodiments, the second object (Object2) 220 is visually indicated/highlighted in the animation panel 200 configuring the brightness of the second object (Object2) 220 to be significantly higher than all other objects in the current frame. In further embodiments, the second object (Object2) 220 is visually indicated/highlighted in the animation panel 200 using a different technique, such as those discussed above in relation to FIG. 2.

In further response to the determination that the second object (Object2) 220 is the currently selected object, the animation application 130 also visually indicates/highlights any transitions 260 (including the transition parameters) associated with the second object (Object2) 220 in the transition panel 250, such as the third transition 260c. In some embodiments, the animation application 130 does so by displaying a second transition highlight box 420 that encloses the third transition 260c associated with the second object (Object2) 220 in the transition panel 250. In other embodiments, the third transition 260c is visually indicated/highlighted in the transition panel 250 using a different technique, such as those discussed above in relation to FIG. 2. As such, the user can easily identify the transitions 260 associated with the second object (Object2) 220 in the transition panel 250, and then modify any of the corresponding transition parameters associated with the second object (Object2) 220, for example, by directly modifying one or more values of the corresponding transition parameters displayed within the transition panel 250.

In further response to the determination that the second object (Object2) 220 is the currently selected object, the animation application 130 also visually indicates/highlights any timelines 280 associated with the second object (Object2) 220 in the timeline panel 270, such as the third timeline 280c. In some embodiments, the animation application 130 does so by displaying a second timeline highlight box 430 that encloses the third timeline 280c associated with the second object (Object2) 220 in the timeline panel 270. In further embodiments, the third timeline 280c is visually indicated/highlighted in the timeline panel 270 using a different technique, such as those discussed above in relation to FIG. 2.

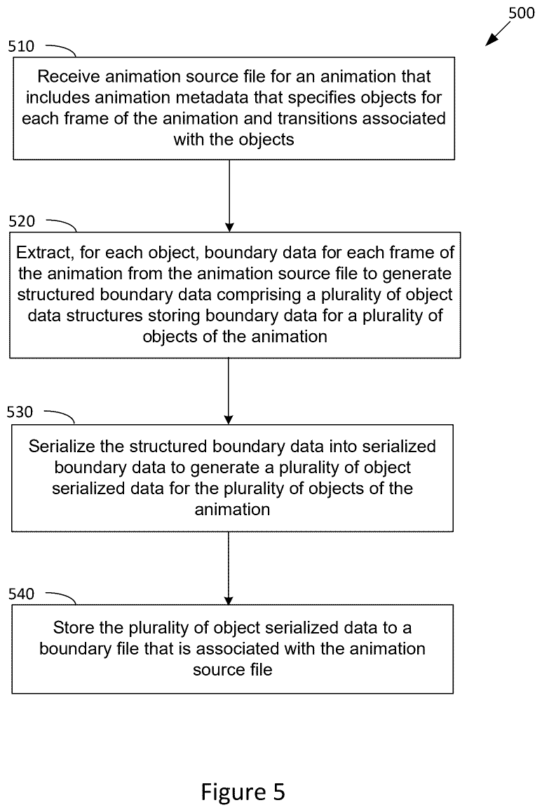

FIG. 5 is a flow diagram of method steps for pre-processing an animation source file, according to various embodiments. Although the method steps are described with reference to the systems of FIGS. 1-4, persons skilled in the art will understand that any system configured to implement the method steps, in any order, falls within the scope of the present disclosure. In some embodiments, a pre-processing method 500 is performed by the animation application 130 executing on the client device 110 and/or server device 160.

As shown, the method 500 begins at step 510, where the animation application 130 receives an animation source file 142 that includes animation metadata for rendering and displaying an animation comprising a sequence of image frames. The animation metadata specifies and defines one or more objects (layers) for each frame of the sequence of frames. Note that the animation metadata specifically includes, for each object, boundary data for each frame of the animation. The animation metadata also specifies and defines one or more transitions associated with the one or more objects, each transition comprising a transition/change of a particular property of a particular object through multiple frames within the sequence of frames of the animation.

The animation application 130 then extracts (at step 520), for each object of the animation, boundary data for each frame of the animation from the animation source file 142 to generate structured boundary data 144. In some embodiments, only the boundary data is extracted from the animation source file 142 and the remaining animation metadata is not extracted to generate the structured boundary data 144. In particular, for each object in the animation, an object data structure is generated for storing the boundary data for the object for each frame of the animation in a structured form. An example of code specifying a first object data structure for a first object is shown in Coding Example 1. Thus, a plurality of object data structures can be generated for storing boundary data for a plurality of objects of the animation, the plurality of object data structures comprising the structured boundary data 144.

The animation application 130 then serializes (at step 530) the structured boundary data 144 into serialized boundary data. In particular, for each object data structure comprising boundary data for a particular object across each frame of the animation, the animation application 130 serializes the object data structure to generate object serialized data that also specifies the boundary data for the particular object across each frame of the animation. An example of code specifying first object serialized data for a first object that corresponds to the first object data structure for the first object is shown in Coding Example 2. In some embodiments, the serialized boundary data is generated by the animation application 130 using a predetermined format and predetermined token identifiers. Thus, the animation application 130 generates a plurality of object serialized data for a plurality of objects of the animation.

The animation application 130 then stores (at step 540) the plurality of object serialized data (generated in step 530) to a boundary file 146, which is then associated with the animation source file 142 received in step 510. In general, the structured boundary data 144 includes boundary data having an explicit structure. In contrast, the serialized boundary data can include a single stream of data having less structure than the structured boundary data 144, and thus requires less storage space than the structured boundary data 144. In addition, the use of predetermined token identifiers also reduces the amount of data in the serialized boundary data relative to the structured boundary data 144. As such, the resulting boundary file 146 storing serialized boundary data requires lower amounts of storage space and processing time and resources to load at runtime than if the boundary file 146 stores the structured boundary data 144. The method 500 then ends.

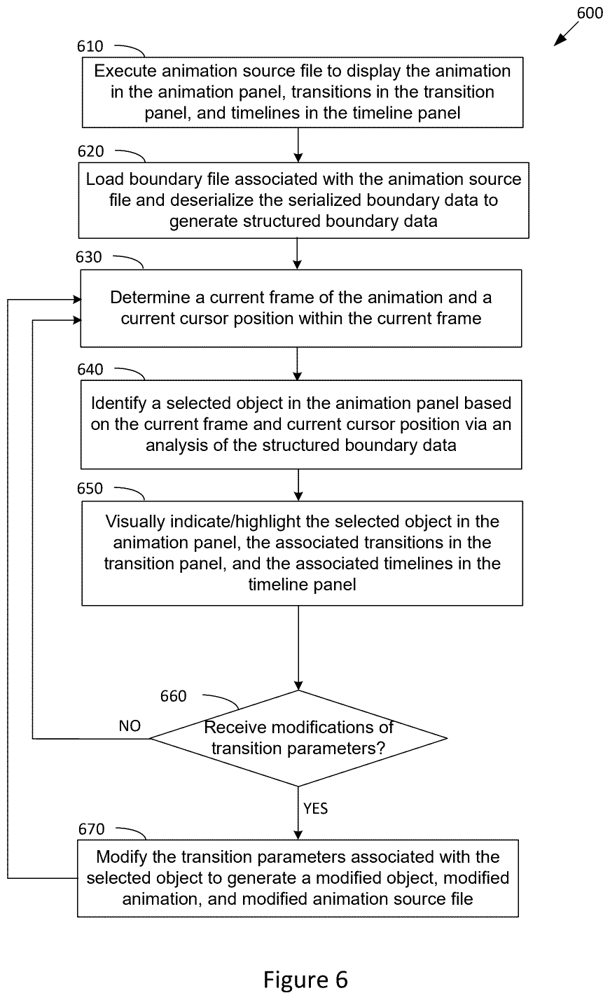

FIG. 6 is a flow diagram of method steps for processing an animation source file and associated boundary file during runtime, according to various embodiments. Although the method steps are described with reference to the systems of FIGS. 1-4, persons skilled in the art will understand that any system configured to implement the method steps, in any order, falls within the scope of the present disclosure. In some embodiments, a runtime method 600 is performed by the animation application 130 executing on the client device 110 and/or server device 160.

As shown, the method 600 begins at step 610, where the animation application 130 receives user input for opening an animation source file 142 for an animation, and in response, loads and executes animation source file 142 to render and display the animation in the animation panel 200, one or more transitions 260 associated with the animation in the transition panel 250, and one or more timelines 280 associated with the animation in the timeline panel 270. In response to the user input for opening an animation source file 142, the animation application 130 also loads and opens (at step 620) a boundary file 146 associated with the animation source file 142 that contains serialized boundary data comprising boundary data for one or more objects in each frame of the animation. The animation application 130 also deserializes the serialized boundary data to generate structured boundary data 144 comprising boundary data for one or more objects in each frame of the animation.

The animation application 130 then determines (at step 630) a current frame of the animation being currently displayed in the animation panel 200 and a current cursor position within the current frame in the animation panel 200. The animation application 130 then identifies (at step 640) a currently selected object in the animation panel 200 based on the current frame and the current cursor position via an analysis of the structured boundary data 144. The animation application 130 then visually indicates/highlights (at step 650) the selected object in the animation panel 200, visually indicates/highlights one or more transitions 260 associated with the selected object in the transition panel 250, and visually indicates/highlights one or more timelines 280 associated with the selected object in the timeline panel 270.

The animation application 130 then determines (at step 660) whether user input for modifying one or more transition parameters of one or more transitions 260 associated with the selected object is received via the transition panel 250. If not (at step 660—No), the method 600 proceeds to step 630. If so (at step 660—Yes), the method 600 proceeds to step 670, where the animation application 130 modifies the one or more transition parameters for the one or more transitions 260 associated with the selected object to generate a modified selected object, which thereby generates a modified animation and a modified animation source file 142. The modified animation source file 142 can then be implemented for use in a type of media. The method 600 then returns to step 630.

In sum, the disclosed techniques provide an improved user interface for an animation application that provides relatively seamless (lag-free) and efficient identification and visualization of selected objects of an animation. In some embodiments, the animation application is configured to perform pre-processing steps on a received animation source file for a particular animation. The pre-processing steps include extracting structured boundary data for each object of the animation across each frame of the animation from the animation source file, serializing the extracted boundary data, and storing the serialized boundary data as a boundary file associated with the animation source file.

During runtime when the user opens the animation source file via the animation application, the animation application is further configured to de-serialize the serialized boundary data in the boundary file to generate the structured boundary data for the objects of the animation for each frame of the animation. The animation application then utilizes the structured boundary data to identify selected objects and generate visualizations of the boundaries of the selected objects. In particular, the user interface of the animation application includes an animation panel that displays one or more objects of a current frame of the animation. As the user moves the cursor over various areas of the current frame, the animation application seamlessly and efficiently identifies a selected object corresponding to a current cursor position and current frame of the animation via an analysis of the structured boundary data, and displays a visual indication of the selected object (such as a boundary box for the selected object). The animation application can quickly analyze the structured boundary data to rapidly and efficiently determine selected objects corresponding to current positions of the cursor and then display visualizations of selected objects.

The disclosed techniques also displays a visual indication of any transitions and transition parameters that are associated with the selected object. In some embodiments, the user interface of the animation application also includes a transition panel that displays transitions and transition parameters that are associated with the various objects of the animation. In these embodiments, when a particular object is selected in the animation panel, the user interface visually indicates/highlights any transitions and transition parameters associated with the selected object that are displayed in the transition panel. The user can then easily identify and modify the transitions and transition parameters associated with the selected object to generate a modified object, a modified animation, and a modified animation source file for use in any variety of media, such as web pages, user interfaces, video games, and the like.

At least one technical advantage of the disclosed techniques relative to the prior art is that the disclosed techniques provide an improved user interface for an animation application that does not require the animation application to access animation source files to identify and visualize selected objects in animations. As such, the improved user interface can provide seamless (lag-free) and efficient identification and visualization of selected objects of an animation. In particular, the animation application uses structured boundary data, rather than an animation source file itself, to determine selected objects and display visual indicators of the selected objects. As a result, the animation application can quickly analyze the structured boundary data to determine and display visualizations of selected objects in a manner that is seamless (lag-free). In addition, the disclosed techniques serialize the structured boundary data and store the serialized boundary data as a boundary file associated with the animation source file, which requires a lower amount of storage resources to store the boundary file and a lower amount of processing time and computational resources to load the boundary file during runtime relative to storing the structured boundary data in the boundary file without serialization. Another technical advantage of the disclosed techniques relative to the prior art is that the disclosed techniques visually indicate/highlight any transitions and transition parameters that are associated with a selected object. Thus, the user can more easily identify and modify the transitions and transition parameters associated with the selected object relative to conventional approaches. These technical advantages represent one or more technological improvements over prior art approaches.

Aspects of the subject matter described herein are set out in the following numbered clauses.

1. In some embodiments, a computer-implemented method for interacting with objects included in an animation comprises deserializing a boundary file that includes serialized boundary data for one or more objects included in the animation to generate structured boundary data for the one or more objects, determining a current cursor position within a current frame of the animation, and determining a selected object within the current frame of the animation based on the current cursor position within the current frame and the structured boundary data.

2. The computer-implemented method of clause 1, wherein the current frame includes a plurality of objects, and further comprising displaying the current frame along with a visual indication of the selected object within the current frame.

3. The computer-implemented method of clauses 1 or 2, wherein displaying the visual indication of the selected object comprises displaying at least a portion of a boundary box that encloses the selected object.

4. The computer-implemented method of any of clauses 1-3, wherein displaying the visual indication of the selected object comprises displaying the selected object with a greater brightness than other objects included in the plurality of objects.

5. The computer-implemented method of any of clauses 1-4, further comprising displaying a plurality of transitions associated with a plurality of objects included in the animation, and displaying a visual indication of at least one transition associated with the selected object.

6. The computer-implemented method of any of clauses 1-5, wherein displaying the visual indication of the at least one transition includes at least one of displaying at least a portion of a highlighted box that encloses the at least one transition, displaying the at least one transition with a greater brightness than other transitions included in the plurality of transitions, or displaying only the at least one transition without displaying the other transitions included in the plurality of transitions.

7. The computer-implemented method of any of clauses 1-6, wherein each transition included in the plurality of transitions corresponds to a set of transition parameters, and further comprising receiving a modification of at least one transition parameter included in a first set of transition parameters corresponding to a first transition associated with the selected object.

8. The computer-implemented method of any of clauses 1-7, further comprising displaying a plurality of timelines associated with a plurality of objects included in the animation, and displaying a visual indication of at least one timeline associated with the selected object.

9. The computer-implemented method of any of clauses 1-8, wherein the serialized boundary data includes a token identifier indicating that boundary data associated with a previous frame included in the animation is the same as boundary data associated with one or more subsequent frames included in the animation.

10. The computer-implemented method of any of clauses 1-9, wherein the serialized boundary data includes a token identifier indicating that a particular object included in the animation does not appear in one or more frames included in the animation.

11. In some embodiments, one or more non-transitory computer-readable media store instructions that, when executed by at least one processor, cause the at least one processor to perform steps comprising deserializing a boundary file that includes serialized boundary data for one or more objects included in the animation to generate structured boundary data for the one or more objects, determining a current cursor position within a current frame of the animation, and determining a selected object within the current frame of the animation based on the current cursor position within the current frame and the structured boundary data.

12. The one or more non-transitory computer-readable media of clause 11, wherein the current frame includes a plurality of objects, and further comprising displaying the current frame along with a visual indication of the selected object within the current frame.

13. The one or more non-transitory computer-readable media of clauses 11 or 12, wherein displaying the visual indication of the selected object comprises displaying at least a portion of a boundary box that encloses the selected object.

14. The one or more non-transitory computer-readable media of any of clauses 11-13, wherein displaying the visual indication of the selected object comprises displaying the selected object with a greater brightness than other objects included in the plurality of objects.

15. The one or more non-transitory computer-readable media of any of clauses 11-14, further comprising displaying a plurality of transitions associated with a plurality of objects included in the animation, and displaying a visual indication of at least one transition associated with the selected object.

16. The one or more non-transitory computer-readable media of any of clauses 11-15, wherein displaying the visual indication of the at least one transition includes at least one of displaying at least a portion of a highlighted box that encloses the at least one transition, displaying the at least one transition with a greater brightness than other transitions included in the plurality of transitions, or displaying only the at least one transition without displaying the other transitions included in the plurality of transitions.

17. The one or more non-transitory computer-readable media of any of clauses 11-16, wherein each transition included in the plurality of transitions corresponds to a set of transition parameters that specify a change of a particular property of a particular object across a plurality of frames of the animation.

18. The one or more non-transitory computer-readable media of any of clauses 11-17, wherein the serialized boundary data includes a token identifier indicating that boundary data associated with a previous frame included in the animation is the same as boundary data associated with one or more subsequent frames included in the animation.

19. The one or more non-transitory computer-readable media of any of clauses 11-18, wherein the serialized boundary data includes a token identifier indicating that a particular object included in the animation does not appear in one or more frames included in the animation.

20. In some embodiments, a system comprises a memory storing instructions, and a processor that is coupled to the memory and, when executing the instructions, is configured to perform the steps of deserializing a boundary file that includes serialized boundary data for one or more objects included in the animation to generate structured boundary data for the one or more objects, determining a current cursor position within a current frame of the animation, and determining a selected object within the current frame of the animation based on the current cursor position within the current frame and the structured boundary data.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for interacting with objects included in an animation, the method comprising:
deserializing a boundary file that includes serialized boundary data for one or more objects included in the animation to generate structured boundary data for the one or more objects;
determining a current cursor position within a current frame of the animation; and
determining a selected object within the current frame of the animation based on the current cursor position within the current frame and the structured boundary data.

2. The computer-implemented method of claim 1, wherein the current frame includes a plurality of objects, and further comprising displaying the current frame along with a visual indication of the selected object within the current frame.

3. The computer-implemented method of claim 2, wherein displaying the visual indication of the selected object comprises displaying at least a portion of a boundary box that encloses the selected object.

4. The computer-implemented method of claim 2, wherein displaying the visual indication of the selected object comprises displaying the selected object with a greater brightness than other objects included in the plurality of objects.

5. The computer-implemented method of claim 1, further comprising:
displaying a plurality of transitions associated with a plurality of objects included in the animation; and
displaying a visual indication of at least one transition associated with the selected object.

6. The computer-implemented method of claim 5, wherein displaying the visual indication of the at least one transition includes at least one of displaying at least a portion of a highlighted box that encloses the at least one transition, displaying the at least one transition with a greater brightness than other transitions included in the plurality of transitions, or displaying only the at least one transition without displaying the other transitions included in the plurality of transitions.

7. The computer-implemented method of claim 5, wherein each transition included in the plurality of transitions corresponds to a set of transition parameters, and further comprising receiving a modification of at least one transition parameter included in a first set of transition parameters corresponding to a first transition associated with the selected object.

8. The computer-implemented method of claim 1, further comprising:
displaying a plurality of timelines associated with a plurality of objects included in the animation; and
displaying a visual indication of at least one timeline associated with the selected object.

9. The computer-implemented method of claim 1, wherein the serialized boundary data includes a token identifier indicating that boundary data associated with a previous frame included in the animation is the same as boundary data associated with one or more subsequent frames included in the animation.

10. The computer-implemented method of claim 1, wherein the serialized boundary data includes a token identifier indicating that a particular object included in the animation does not appear in one or more frames included in the animation.

11. One or more non-transitory computer-readable media storing instructions that, when executed by at least one processor, cause the at least one processor to perform steps comprising:
deserializing a boundary file that includes serialized boundary data for one or more objects included in the animation to generate structured boundary data for the one or more objects;
determining a current cursor position within a current frame of the animation; and
determining a selected object within the current frame of the animation based on the current cursor position within the current frame and the structured boundary data.

12. The one or more non-transitory computer-readable media of claim 11, wherein the current frame includes a plurality of objects, and further comprising displaying the current frame along with a visual indication of the selected object within the current frame.

13. The one or more non-transitory computer-readable media of claim 12, wherein displaying the visual indication of the selected object comprises displaying at least a portion of a boundary box that encloses the selected object.

14. The one or more non-transitory computer-readable media of claim 12, wherein displaying the visual indication of the selected object comprises displaying the selected object with a greater brightness than other objects included in the plurality of objects.

15. The one or more non-transitory computer-readable media of claim 11, further comprising:
displaying a plurality of transitions associated with a plurality of objects included in the animation; and
displaying a visual indication of at least one transition associated with the selected object.

16. The one or more non-transitory computer-readable media of claim 15, wherein displaying the visual indication of the at least one transition includes at least one of displaying at least a portion of a highlighted box that encloses the at least one transition, displaying the at least one transition with a greater brightness than other transitions included in the plurality of transitions, or displaying only the at least one transition without displaying the other transitions included in the plurality of transitions.

17. The one or more non-transitory computer-readable media of claim 15, wherein each transition included in the plurality of transitions corresponds to a set of transition parameters that specify a change of a particular property of a particular object across a plurality of frames of the animation.

18. The one or more non-transitory computer-readable media of claim 11, wherein the serialized boundary data includes a token identifier indicating that boundary data associated with a previous frame included in the animation is the same as boundary data associated with one or more subsequent frames included in the animation.

19. The one or more non-transitory computer-readable media of claim 11, wherein the serialized boundary data includes a token identifier indicating that a particular object included in the animation does not appear in one or more frames included in the animation.

20. A system, comprising:
a memory storing instructions; and
a processor that is coupled to the memory and, when executing the instructions, is configured to perform the steps of:
deserializing a boundary file that includes serialized boundary data for one or more objects included in the animation to generate structured boundary data for the one or more objects;
determining a current cursor position within a current frame of the animation; and
determining a selected object within the current frame of the animation based on the current cursor position within the current frame and the structured boundary data.
